(19) United States
(12) Patent Application Publication
(10) Pub. No.: US 2018/0032925 A1
(43) Pub. Date: Feb. 1, 2018

(54) Colored Time Software System

(71) Applicant: Derrick Meade, Irvine, CA (US)

(72) Inventor: Derrick Meade, Irvine, CA (US)

(21) Appl. No.: 15/221,514

(22) Filed: Jul. 27, 2016

(51) Int. Cl. G06Q 10/02; G06Q 10/10; G06Q 50/00

(52) U.S. Cl. CPC G06Q 10/025; G06Q 50/01; G06Q 10/1095

(57) ABSTRACT

The present invention relates to how Musicpad llc programs and it's software for computers, tablets and mobile app, web based and native platforms will display information by using assigned colors, not limited to but includes variations of red, Yellow, Green to assist user on finding status's on events, sales of tickets and hotel lodging on a device such as Smartphone or tablet. The users location will determine if any tickets, events or hotels available within distance that correlate with user's preferences. The message is triggered when the device enters within the given radius within users location. green=event has started, tickets hotels are available Red=event has not started tickets or hotel are not available. All software development for the color time management system maybe used in combination in one program or use as individual standalone programs for each feature contain an event status, ticket status or hotel availability.

### BACKGROUND OF THE INVENTION

### 1. Field of the Invention

The present invention relates to a software programmed Internet messaging systems; and, more particularly, to display of a Smartphone, tablet or mobile device, or stationary device, having Internet connectivity and GPS technology. it has become complicated to list and find events. Many methods contain numbers time and date in its current format gives people who seek information such as event time, tickets sales and available hotel lodging is complicated to correlate information. This software invention gives users the information with a glance knowing when and what is the time status of events, status of tickets sale and/or available hotels lodging all by the color of pin or the icon near associated information.

### CLAIMS

The present invention is a software system that will be the identity of Musicpad llc an event social network for managing start time and end time for multiple events, purchasing tickets and booking hotel rooms using a colored based system this software programmed for but not limited to computers, devices created and manufactured by Musicpad llc, tablets, mobile applications web based and native platforms to display event time information by use of variation of colors red yellow and green also shapes and/or icons containing these colors. The event reminder will be recognized and determined by color informing user at a glance the current status of the events beginning or its endings. The color of the object displayed on the on all platforms of web-based and mobile application system, along with event category, details and countdown clock will be used in conjunction to represent the beginning of an event displaying a color and another color representing the ending of the event.

Different colors will be assign to describe the months, week, day or up to the minute that each event will start by displaying the corresponding colored objects within throughout the event details using specifically but not limited to any variation of red, yellow and green. A colored based event reminder application that determines GPS coordinates of the location of mobile device, user event preference using events closest to location of the web based and mobile device application system. each event will be assign specific color depending on start time and will change as the event starts or ends letting user choose, schedule and arrive at all desired event(s) on time at a glance by using this system.

This will allow users to rely less on physical time 7 pm but know that is 7 pm because the object has turned “green” representing the event has started.

While music is streaming along with the color management event finder Green representing the event has started, example of music matching current artist streaming let user know the artist that he/she is listening to has an event happening right now yellow will be on display indicates the event is about to start red indicates the event has not started Color management system applied to Ticket purchases Red icon alert new tickets not available but will be offered for sale Yellow icon tickets are being ready to sale along with further instruction provided by administrator Green icon Tickets are for sale and ready to purchase, example matches current streaming music artist alerting the user that the current playing artist he/she is listening to has tickets for sale Color management system applied to hotel Booking Purchases Red icon hotel are sold out Yellow icon Hotel are approaching full capacity Green icon hotel is ready for purchase example Let user know that the artist he is listening and might have purchased tickets for to has hotel rooms available near the venue.

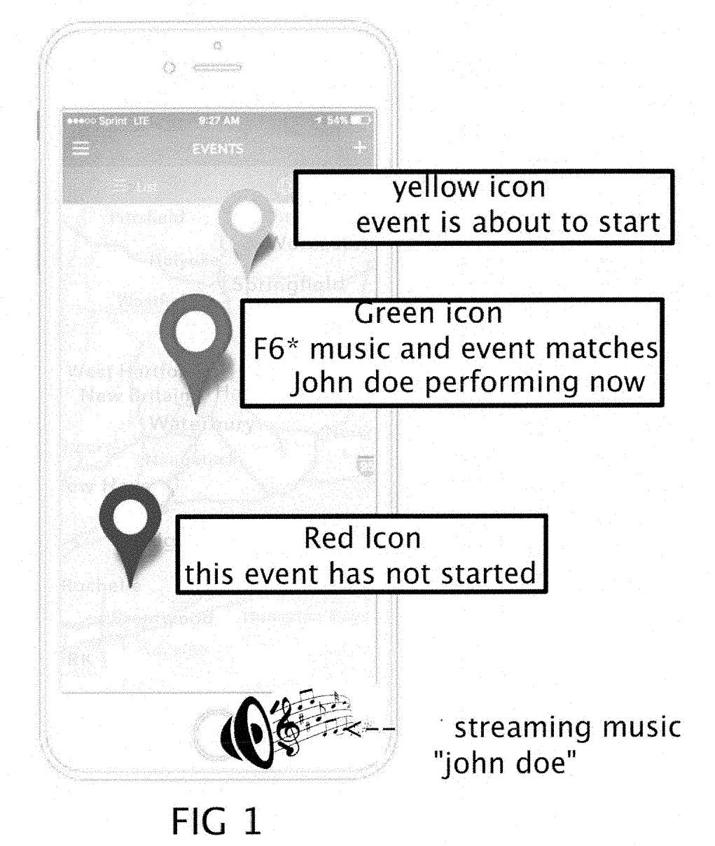

FIGS. 1 2 and 3 is our colored software application working together with a map software using gps format, the pins represent the location and the time of the event starts, tickets for sale or available hotel lodging depends what color the pins are while streaming music highlighting the artist ticket and event location.

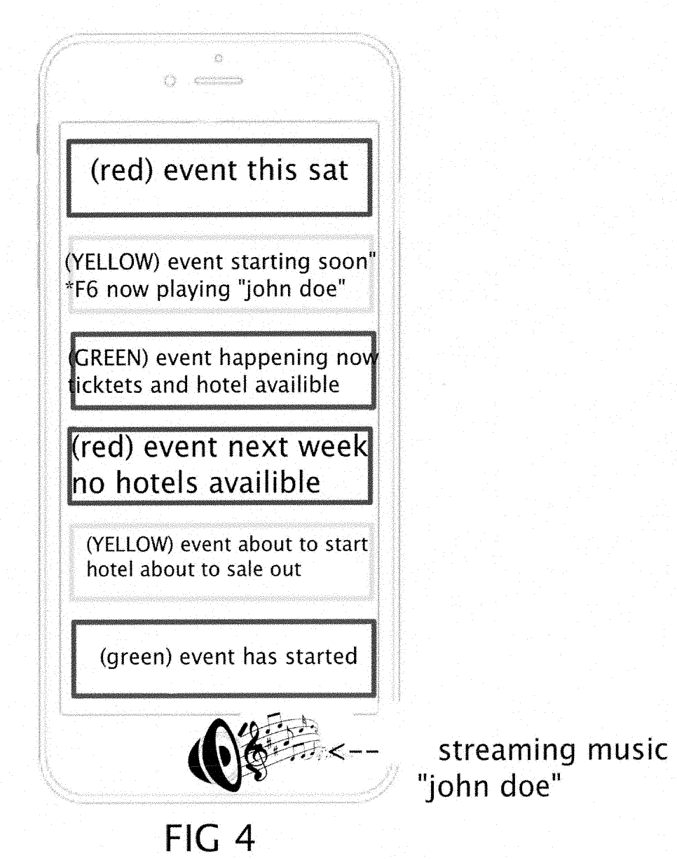

FIG. 4 is our colored software application working together using gps format, the colored list format represent the time of the event starts, tickets for sale or available hotel lodging depends what color the shape or icon thats next to or surrounds the information while streaming music highlighting the location of the artist current event and tickets if any.

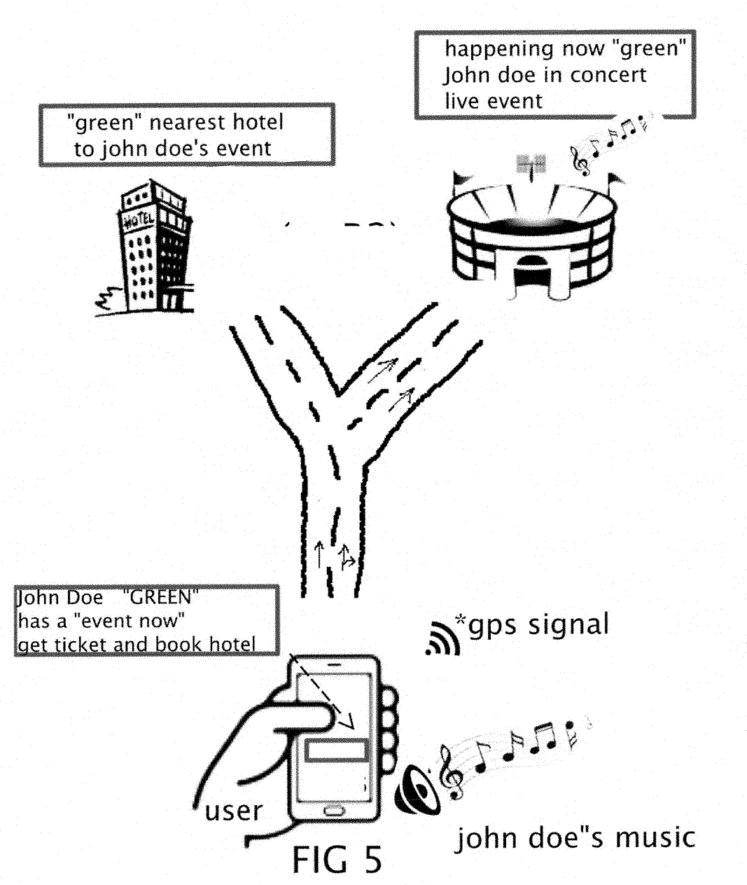

FIG. 5 is our colored software application working together using gps showing the user with a device as he searches for the time of the event, tickets for sale or available hotel lodging of the current music streaming artist near his location.

The software application working together, will help our user easily find events, buy tickets and stay the night near the venue making it a complete trip to see the artist they love. The event color management system also used in conjunction with streaming music on all supported platforms pulling music ID information aka music metadata. When figure Music audio streaming device is active it will match the song id it will display and highlight the event by Musicpad color time system closest to the user's location. *see music ID tags definition in 23-4

Music meta data will be pulled from current audio in any format that is streaming or playing on Any of our mobile web, website or native applications Will be used in conjunction to show the artist currently location or upcoming events. The meta-data will automatically match the artist event data within our color management system and will display the artist current or upcoming event while the artist song is in queue or currently streaming.

Definition *23-4 Music metadata, which is also commonly referred to as ID3 metadata, is the information embedded in an audio file that is used to identify the content. This data which is in most (if not all) of the files in your digital music library, can be used by a wide range of consumer electronic devices and software programs. The most common reason for using embedded metadata in a digital audio file is for identification purposes of artist and/or company holding the rights.

1. The present invention is a software system that will be the identity of Musicpad llc an event social network for managing start time and end time for multiple events, purchasing tickets and booking hotel rooms using a colored based system this software programmed for but not limited to computers, tablets, mobile devices and other hardware created and manufactured by Musicpad llc, this software will be developed for applications, web based and native platforms to display event time information by use of color various shapes and/or icons. The event reminder will be recognized and determined by color informing user at a glance the current status of the events beginning or its endings. The color of the object displayed on the on all platforms of web-based and mobile application system, along with event category, details and countdown clock will be used in conjunction to represent the beginning of an event displaying a color and another color representing the ending of the event.

2. Different colors will be assign to describe the months, week, day or up to the minute that each event will start by displaying the corresponding colored objects within throughout the event details using specifically but not limited to any variation of red, yellow and green. A colored based event reminder application that determines GPS coordinates of the location of mobile device, user event preference using events closest to location of the web based and mobile device application system. each event will be assign specific color depending on start time and will change as the event starts or ends letting user choose, schedule and arrive at all desired event(s) on time at a glance by using this system.

3. This will allow users to rely less on physical time 7 pm but know that is 7 pm because the object has turned “green” representing the event has started.

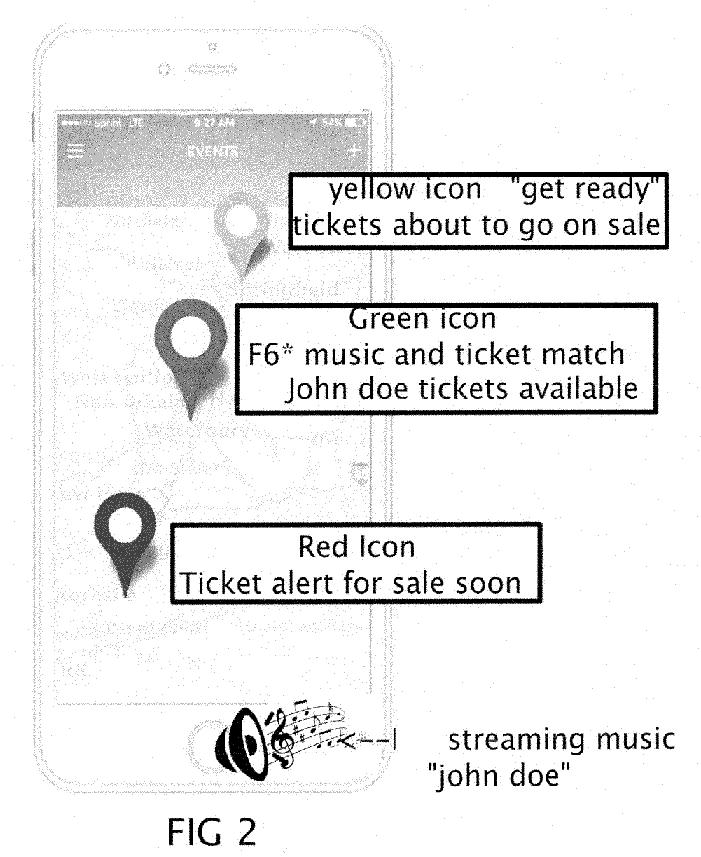

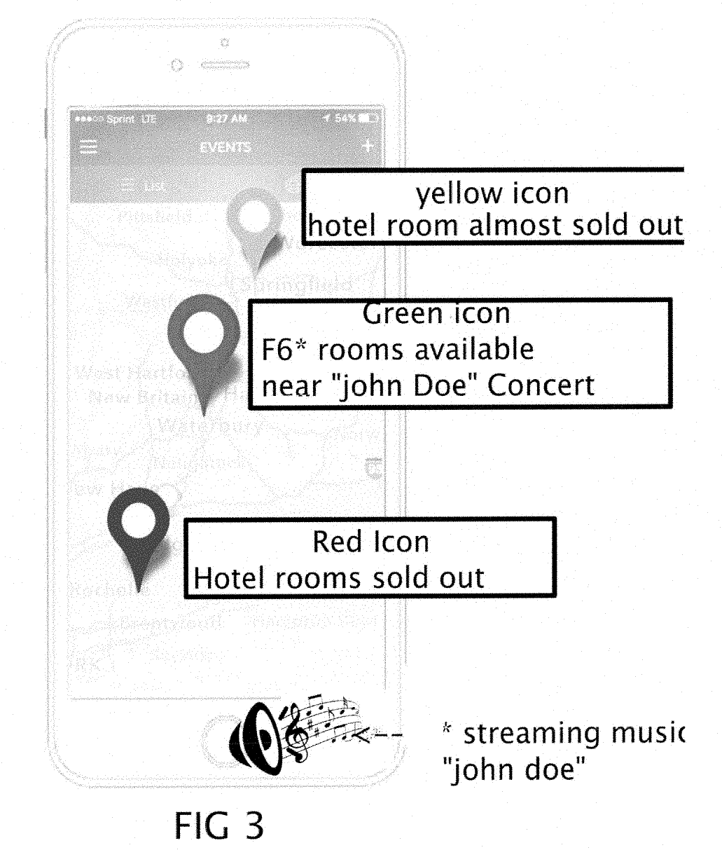

4. While music is streaming as seen in all the figures along with the color management event finder Green representing the event has started, example of music matching current artist streaming FIG. 5 let user know the artist that he/she is listening to has an event happening right now yellow will be on display indicates the event is about to start red indicates the event has not started Color management system applied to Ticket purchases FIG. 3 Red icon alert new tickets not available but will be offered for sale Yellow icon tickets are being ready to sale along with further instruction provided by administrator Green icon Tickets are for sale and ready to purchase, example FIG. 2 matches current streaming music artist alerting the user that the current playing artist he/she is listening to has tickets for sale Color management system applied to Hotel Booking Purchases FIG. 3 Red icon hotel are sold out Yellow icon Hotel are approaching full capacity Green icon hotel is ready for purchase example FIG. 3 Let user know that the artist he is listening and might have purchased tickets for to has hotel rooms available near the venue.

5. FIG. 4 is a current our application working together, helping our user easily find events, buy tickets and stay the night near the venue making it a complete trip to see the artist they love FIG. 1 The event color management system also used in conjunction with streaming music on all supported platforms pulling music ID information aka music metadata. When figure Music audio streaming device is active it will match the song id it will display and highlight the event by Musicpad color time system closest to the user's location. *see music ID tags aka meta data in definition in claim 7

6. Music meta data will be pulled from current audio in any format that is streaming or playing on Any of our mobile web, website or native applications Will be used in conjunction to show the artist currently location or upcoming events. The meta-data will automatically match the artist event data within our color management system and will display the artist current or upcoming event while the artist song is in queue or currently streaming.

7. Music metadata, which is also commonly referred to as ID3 metadata, is the information embedded in an audio file that is used to identify the content. This data which is in most (if not all) of the files in your digital music library, can be used by a wide range of consumer electronic devices and software programs. The most common reason for using embedded metadata in a digital audio file is for all information available streaming musician.
